(19) United States
(12) Patent Application Publication
(10) Pub. No.: US 2025/0035804 A1
(43) Pub. Date: Jan. 30, 2025

(54) MINIMUM BOUNDING BOX-BASED GRID DETERMINATION FOR SEISMIC SURVEYS

(71) Applicant: SAUDI ARABIAN OIL COMPANY, DHAHRAN (SA)

(72) Inventor: Apostolos Kontakis, Delft (NL)

(73) Assignee: ARAMCO OVERSEAS COMPANY B.V., The Hague (NL)

(21) Appl. No.: 18/362,646

(22) Filed: Jul. 31, 2023

(30) Foreign Application Priority Data
Jul. 26, 2023 (GR) 20230100618

(51) Int. Cl. G01V 1/30

(52) U.S. Cl. CPC G01V 1/301; G01V 2210/121; G01V 2210/1425

(57) ABSTRACT

A method and a system for determining a minimum bounding box-based grid are disclosed. The method includes obtaining a seismic survey of an area and constructing a convex hull of the seismic survey area. Further, the method includes determining a minimum bounding box containing a minimum convex hull area and generating two linear maps based on the minimum bounding box using a rotation angle and an axis origin. The two linear maps are used to generate a grid populated by geological models of a subsurface.

### BACKGROUND

Active seismic acquisition is a particular type of remote sensing, in which the amplitude of mechanical waves traveling in the earth is sampled for the purpose of recovering information about the subsurface. Active surveys in particular use mechanical waves that are created deliberately by man-made sources.

By using the recorded data and mathematical models describing the physics of wave propagation in the earth, it is possible to extract information such as the location of boundaries between layers with a different material composition and the speed of the mechanical waves within each layer. This information can be useful in exploration (e.g., for oil and gas reservoirs, aquifers, mineral deposits and geothermal reservoirs). It is also often used for monitoring purposes such as registering changes around producing reservoirs and to monitoring CO2 sequestration efforts.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method including obtaining a seismic survey of an area and constructing a convex hull of the seismic survey area. Further, the method includes determining a minimum bounding box containing a minimum convex hull area and generating two linear maps based on the minimum bounding box using a rotation angle and an axis origin. The two linear maps are used to generate a grid populated by geological models of a subsurface.

In general, in one aspect, embodiments disclosed herein relate to a non-transitory computer readable medium storing a set of instructions executable by a computer processor for predicting well production of a reservoir. The set of instructions includes the functionality for obtaining a seismic survey of an area and constructing a convex hull of the seismic survey area. Further, a minimum bounding box containing a minimum convex hull area is determined and two linear maps based on the minimum bounding box are generated using a rotation angle and an axis origin. The two linear maps are used to generate a grid populated by geological models of a subsurface.

In general, in one aspect, embodiments disclosed herein relate to a system including a processor comprising a functionality for obtaining a seismic survey of an area and constructing a convex hull of the seismic survey area. Further, a minimum bounding box containing a minimum convex hull area is determined and two linear maps based on the minimum bounding box are generated using a rotation angle and an axis origin. The two linear maps are used to generate a grid populated by geological models of a subsurface.

Other aspects and advantages will be apparent from the following description and the appended claims.

### BRIEF DESCRIPTION OF DRAWINGS

Wherever possible, like or identical reference numerals are used in the figures to identify common or the same elements. The figures are not necessarily to scale and certain features and certain views of the figures may be shown exaggerated in scale for purposes of clarification.

FIG. 1 depicts a seismic acquisition system in accordance with one or more embodiments.

FIG. 2 shows an example of acquisition geometry in accordance with one or more embodiments.

FIG. 3 shows a flowchart in accordance with one or more embodiments.

FIGS. 4A-C show a process of building a convex hull encompassing a survey.

FIG. 5 shows an exemplary schematic depiction of three candidate bounding boxes for the survey.

FIG. 6 shows an exemplary flowchart for method for minimum bounding-box determination in accordance with one or more embodiments.

FIG. 7 shows an exemplary schematic depiction of survey grids generated using different methods in accordance with one or more embodiments.

FIG. 8 shows a computer system in accordance with one or more embodiments.

### DETAILED DESCRIPTION

In the following detailed description of embodiments disclosed herein, numerous specific details are set forth in order to provide a more thorough understanding disclosed herein. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

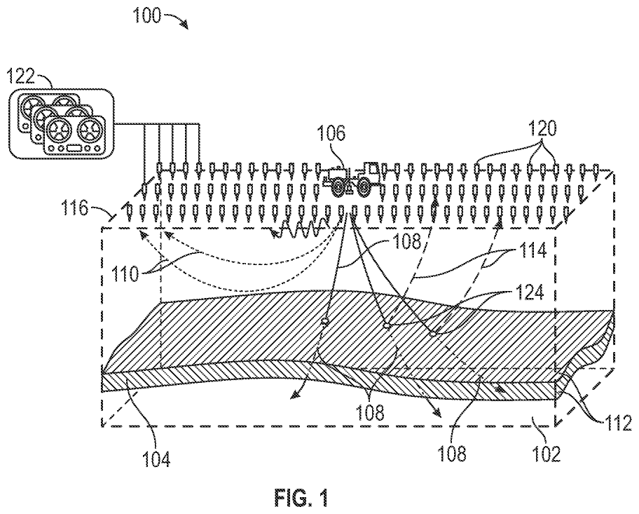

In the following description of FIGS. 1-8, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Embodiments disclosed herein provide a method and system for minimum bounding box-based grid determination based on computational geometry. Specifically, the method includes constructing the convex hull of the survey area. Further, a key property of convex hulls is exploited to calculate a bounding box containing the survey that is guaranteed to be the minimum one. The rotation angle and an axis origin are extracted from the box parameters and then used to formulate two linear maps that can be used to translate between world and grid coordinates. The resulting grid has the orientation in which a survey bounding box aligned to the axes is the minimum one. The amount of unoccupied space is therefore minimized. Embodiments disclosed herein may be implemented such that the world coordinates are processed one by one, making it suitable for use in seismic processing platforms where chunks of traces are processed sequentially.

Certain seismic processing operations require defining a rectangular grid over the survey area and transform world coordinates to grid coordinates. A suitable grid coordinate system may be decided already during the acquisition planning phase and delivered to a user with the obtained seismic survey. Alternatively, the grid may need to be constructed from scratch. A typical way of doing this, which is sometimes sufficient, is to find the minimum or maximum coordinates in each dimension and use them to define a survey bounding box. The bottom-left corner of the bounding box is then used as the new origin. Further, the bounding box is divided in segments according to user-defined grid spacing for each dimension to form the grid.

FIG. 1 shows a seismic acquisition system (100) configured for acquiring a seismic dataset pertaining to a subterranean region of interest (102). The subterranean region of interest (102) may or may not contain a hydrocarbon reservoir (104). The purpose of the seismic survey may be to determine whether or not a hydrocarbon reservoir (104) is present within the subterranean region of interest (102).

The seismic acquisition system (100) may utilize a seismic source (106) positioned on the surface of the earth (116). On land the seismic source (106) is typically a vibriosis truck (as shown) or, less commonly, explosive charges, such as dynamite, buried to a shallow depth. In water, particularly in the ocean, the seismic source may commonly be an air gun (not shown) that releases a pulse of high-pressure gas when activated. Whatever its mechanical design, the seismic source (106), when activated, generates radiated seismic waves, such as those whose paths are indicated by the rays (108). The radiated seismic waves may be bent (“refracted”) by variations in the speed of seismic wave propagation within the subterranean region (102) and return to the surface of the earth (116) as refracted seismic waves (110). Alternatively, radiated seismic waves may be partially or wholly reflected by seismic reflectors, at reflection points such as (224), and return to the surface as reflected seismic waves (114). Seismic reflectors may be indicative of the geological boundaries (112), such as the boundaries between geological layers, the boundaries between different pore fluids, faults, fractures or groups of fractures within the rock, or other structures of interest in the seismic for hydrocarbon reservoirs.

At the surface, the refracted seismic waves (110) and reflected seismic waves (114) may be detected by seismic receivers (120). On land a seismic receiver (120) may be a geophone (that records the velocity of ground motion) or an accelerometer (that records the acceleration of ground motion). In water, the seismic receiver may commonly be a hydrophone that records pressure disturbances within the water. Irrespective of its mechanical design or the quantity detected, seismic receivers (120) convert the detected seismic waves into electrical signals, that may subsequently be digitized and recorded by a seismic recorder (122) as a time-series of samples. Such a time-series is typically referred to as a seismic “trace” and represents the amplitude of the detected seismic wave at a plurality of sample times. Usually, the sample times are referenced to the time of source activation and the sample times are referred to as “recording times”. Thus, zero recording time occurs at the moment the seismic source is activated.

Each seismic receiver (120) may be positioned at a seismic receiver location that may be denoted (xᵣ, yᵣ) where x and y represent orthogonal axes, such as North-South and East-West, on the surface of the earth (116) above the subterranean region of interest (102). Thus, the refracted seismic waves (110) and reflected seismic waves (114) generated by a single activation of the seismic source (106) may be represented as a three-dimensional “3D” volume of data with axes (xᵣ, yᵣ, t) where t indicates the recording time of the sample, i.e., the time after the activation of the seismic source (106).

Typically, a seismic survey includes recordings of seismic waves generated by one or more seismic sources (106) positioned at a plurality of seismic source locations denoted (xₛ, yₛ). In some cases, a single seismic source (106) may be used to acquire the seismic survey, with the seismic source (106) being moved sequentially from one seismic source location to another. In other cases, a plurality of seismic sources, such as seismic source (106) may be used, each occupying and being activated (“fired”) sequential at a subset of the total number of seismic source locations used for the survey. Similarly, some or all of the seismic receivers (120) may be moved between firing of the seismic source (106). For example, seismic receivers (120) may be moved such that the seismic source (106) remains at the center of the area covered by the seismic receivers (120) even as the seismic source (106) is moved from one seismic source location to the next. In other cases, such as marine seismic acquisition (not shown) the seismic source may be towed a short distance behind a seismic vessel and strings of receivers attached to multiple cables (“streamers”) are towed behind the seismic sources. Thus, a seismic dataset, the aggregate of all the seismic data acquired by the seismic survey, may be represented as a five-dimensional volume, with coordinate axes (xᵣ, yᵣ, yₛ, yₛ, t).

To determine earth structure, including the presence of hydrocarbons, the seismic data set may be processed. Processing a seismic dataset includes a sequence of steps designed to correct for near-surface effects, attenuate noise, compensate for irregularities in the seismic survey geometry, calculate a seismic velocity model, image reflectors in the subterranean and calculate a plurality of seismic attributes to characterize the subterranean region of interest to determine a drilling target. Critical steps in processing seismic data include a seismic migration. Seismic migration is a process by which seismic events are re-located in either space or time to their true subsurface positions.

Seismic noise may be any unwanted recorded energy that is present in a seismic data set. Seismic noise may be random or coherent and its removal, or “denoising,” is desirable in order to improve the accuracy and resolution of the seismic image. For example, seismic noise may include, without limitation, swell, wind, traffic, seismic interference, mud roll, ground roll, and multiples. A properly processed seismic data set may aid in decisions as to if and where to drill for hydrocarbons. Processing a seismic dataset to form a seismic image may include but is not limited to: applying quality control methods to identify and correct for anomalous data (e.g., from a faulty seismic receiver (120)); application of a bandpass filter to remove low signal-to-noise (SNR) frequency bands; and normal moveout (NMO) correction.

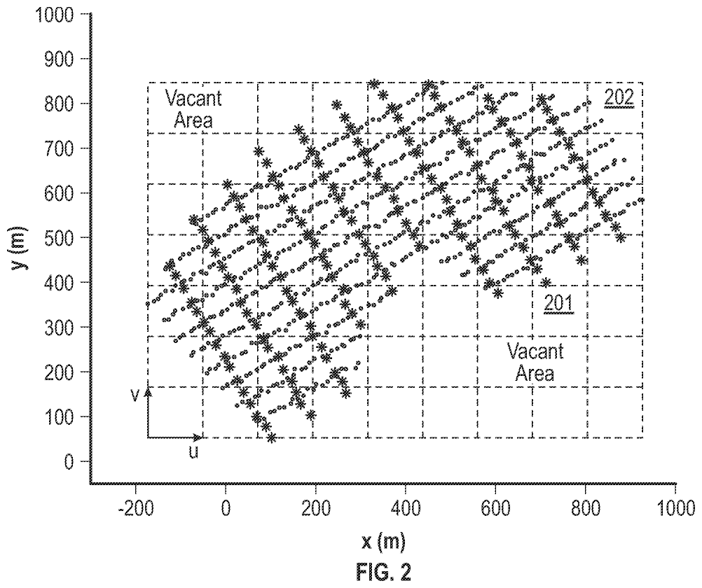

FIG. 2 shows an example of a bounding box. Specifically, red asterisks depict source activation locations (201) and black dots indicate receiver locations (202). Determining a survey bounding box from the extent of the world coordinates alone may lead to bounding boxes that are larger than necessary. When the survey area is tilted with respect to the world-coordinate axes, as shown on FIG. 2, the resulting grid may have big areas that are not populated with source (201) and receiver (202) locations. Seismic processing systems may use the grid to construct volumes storing subsurface properties. Having the box cover empty areas may be wasteful, as it leads to excessive disk and main memory consumption when handling said volumes. Additionally, having the box cover empty areas may impact the visualization of the results and quality control efforts.

To remedy the box covering empty areas, a rotation may be used when transforming from world to grid coordinates. Using rotation may enable building a tighter bounding box that is also aligned with the grid axes. However, it is necessary to calculate the amount of rotation needed to achieve a bounding box with a smaller area. To achieve a bounding box with a smaller area, common data science techniques may be used, such as regression (e.g., fitting a line through the source or receiver coordinates) and principal component analysis (e.g., extracting the angle it forms with one of the world axes). Due to the low dimensionality of the problem with only two axes being involved, it is easy to process all source and receiver coordinates in batches and parallelize both of these methods when applying to large datasets. The disadvantage of this method is there is no guarantee that a grid designed using these methods will lead to a bounding box that is simultaneously grid-aligned and minimum (e.g., having the smallest area out of all possible bounding rectangles that contain the survey).

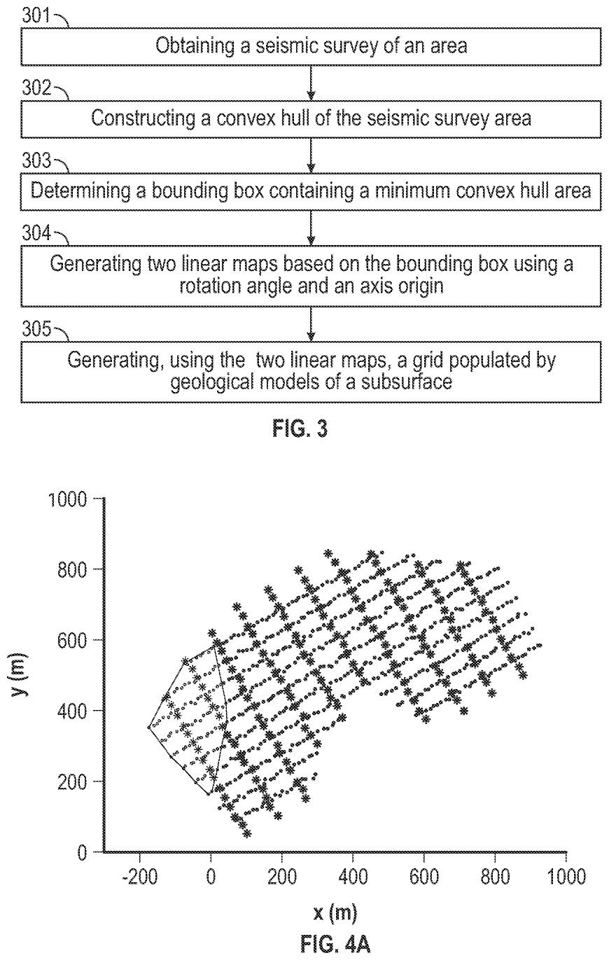

FIG. 3 shows a flowchart in accordance with one or more embodiments for minimum bounding box-based grid determination. Specifically, in Block 301, a seismic survey is obtained. In one or more embodiments, seismic surveys are obtained using a predetermined acquisition geometry, defined by a set of spatial locations at which a source will be activated and a set of spatial coordinates at which receivers will be placed to record mechanical waves. The receiver locations may be different for each source activation. The receivers record a seismogram for each source combination realized in the field, commonly referred to as a trace. The source and receiver coordinates associated with each trace are also stored, using some a coordinate system such as a world coordinate system.

In Block 302, a convex hull of the seismic survey area is determined based on the obtained seismic survey. Seismic waves, produced by the source, are examined during the seismic survey and the seismic waves are represented as seismic traces. Specifically, the seismic traces represent the amplitude of strength of seismic waves at different points in time. Initially, source coordinates are defined for a number N of recorded traces

$$:= \{ {x}_{i}^{s} : i = 1 , 2 , ... , N \} , {x}_{i}^{s} := ( {x}_{i}^{s} , {y}_{i}^{s} ) \qquad ( Equation 1 )$$

and receiver coordinates are defined for a number N of recorded traces

$$:= \{ {x}_{i}^{r} : i = 1 , 2 , ... , N \} , {x}_{i}^{r} := ( {x}_{i}^{r} , {y}_{i}^{r} ) \qquad ( Equation 2 )$$

Where components xᵢ^{s(r)} and yᵢ^{s(r)} are the x and y-coordinates of the source and receiver, respectively, for the i-th trace. In one or more embodiments, elements of [symbol] and [symbol] sets may not be unique.

Further, after defining source and receiver coordinates, a user determines the set of points [symbol] that is going to be used to construct the grid. In one or more embodiments, different points may be used based on the purpose for which the grid will be used. In one or more embodiments, the source and receiver coordinates of the entire survey are used (e.g., [symbol] := [symbol] ∪ [symbol] ). Alternatively, only sources ( [symbol] := [symbol] ), only receivers ( [symbol] := [symbol] ), or common midpoint coordinates may be used.

In one or more embodiments the determined set of points [symbol] is used to calculate a convex hull of all points in [symbol] . In computational geometry, the convex hull represents the smallest convex polygon that encloses a set of points in a plane. Said another way, the convex hull of a set of points [symbol] in Euclidean space is the smallest convex set containing [symbol] . A set [symbol] is said to be convex if for any points a, b∈ [symbol] , every point on the straight-line segment joining them is also in [symbol] . In one or more embodiments, different algorithms may be used to build the convex hull of a set of points. Specifically, when all coordinates are available at the same time for processing, it is computationally beneficial to use a Kirkpatrick-Seidel algorithm that divides the points into subsets and recursively computes the convex hull of each subset. Alternatively, in one or more embodiments, a Quickhull algorithm that recursively partitions the points into subsets that lie on either side of a line, and then constructs the convex hull from those subsets may be used. Kirkpatrick-Seidel and Quickhull algorithms exploit access to any element of [symbol] is possible at any time, achieving optimal computational performance.

In one or more embodiments, a procedure ConvexHull ( ) may be any convex hull algorithm that accepts a set of points [symbol] and returns a set of points [symbol] defining the convex hull

$$← ConvexHull ( χ ) . \qquad ( Equation 3 )$$

Where a left arrow ← indicates assignment. The elements of [symbol] are convex polygon vertices xₖ^{c}:=(xₖ^{c}, yₖ^{c}), k=1, 2, . . . , | [symbol] |, where | [symbol] | is a cardinality of [symbol] . In one or more embodiments, the elements of [symbol] are ordered such that two successive elements xₖ^{c} and xₖ₊₁^{c} define an edge of the convex hull.

In some embodiments, when the set of points [symbol] is not available for processing in one go, subsets of the set of points [symbol] may be incrementally obtained from an external storage to be processed in parts (e.g., Preparata algorithm based on a divide-and-conquer approach, where the rectangles are recursively divided into smaller subsets until the problem can be solved using a simple algorithm). The set [symbol] is initially empty [symbol] ←Ø. As such, when an element xᵢ:=(xᵢ, yᵢ)∈ [symbol] becomes available, the convex hull is updated by taking the new point into account

$$← ConvexHull ( , {x}_{i} ) . \qquad ( Equation 4 )$$

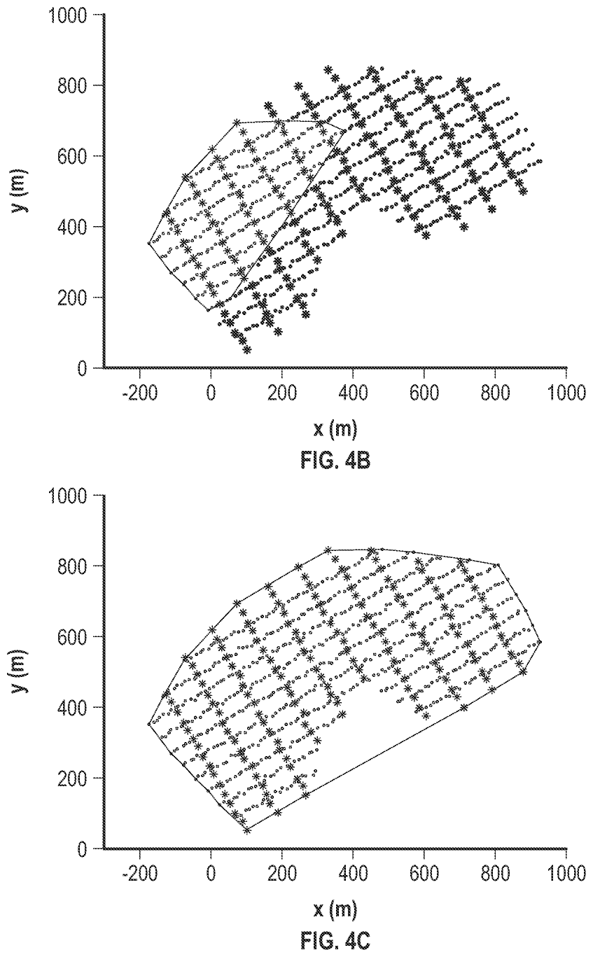

FIGS. 4A-C show three snapshots of a process of convex hull when the set of points [symbol] is progressively being processed. Specifically, FIG. 4A shows 13% of survey coordinates being processed, where red dots depict unprocessed points and blue dots depict the processed points. FIG. 4B shows 35% of survey coordinates being processed. FIG. 4C shows the entirety of survey coordinates being processed. The blue line delineates the convex hull of the processed locations.

In Block 303, after the elements of [symbol] have been processed, [symbol] contains the vertices of the convex hull of all points in [symbol] used to determine a minimum bounding box of [symbol] . Specifically, each edge of the convex hull is used to build a candidate bounding box and calculate its area. The minimum bounding box is guaranteed to be collinear with one of the edges of the convex hull. As such, only a finite number of possible bounding boxes need be considered.

In one or more embodiments, each point is defined by xₖ^{c} and xₖ₊₁^{c}, the angle θₖ with the x-axis is calculated

$${θ}_{k} := {tan}^{- 1} ( \frac{{y}_{k + 1}^{c} - {y}_{k}^{c}}{{x}_{k + 1}^{c} - {x}_{k}^{c}} ) . \qquad ( Equation 5 )$$

Further, each element of [symbol] is rotated clockwise by θₖ radians to produce the set of rotated coordinates

$$← Rotate ( , {θ}_{k} ) . \qquad ( Equation 6 )$$

The implementation of a process Rotate ( ) involves performing the matrix-vector multiplication

$${x}_{k}^{w} = R ( {θ}_{k} ) {x}_{k}^{c} , with R ( {θ}_{k} ) := [ \begin{matrix}cos ( {θ}_{k} ) & sin ( {θ}_{k} ) \\ - sin ( {θ}_{k} ) & cos ( {θ}_{k} )\end{matrix} ] . \qquad ( Equation 7 )$$

The next step is to calculate the extent of the candidate bounding box by finding the minimum x- and y-coordinates in W:

$${x}_{min , k}^{w} := min ( \{ {x}_{1}^{w} , {x}_{2}^{w} , ... , {x}_{K}^{w} \} ) , \qquad ( Equation 8 )$$

$${x}_{max , k}^{w} := max ( \{ {x}_{1}^{w} , {x}_{2}^{w} , ... , {x}_{K}^{w} \} ) , \qquad ( Equation 9 )$$

$${y}_{min , k}^{w} := min ( \{ {y}_{1}^{w} , {y}_{2}^{w} , ... , {y}_{K}^{w} \} ) , \qquad ( Equation 10 )$$

$${y}_{max , k}^{w} := max ( \{ {y}_{1}^{w} , {y}_{2}^{w} , ... , {y}_{K}^{w} \} ) , \qquad ( Equation 11 )$$

with area Aₖ is simply the product of the extent in each dimension,

$${A}_{k} := ( {x}_{max , k}^{w} - {x}_{min , k}^{w} ) ( {y}_{max , k}^{w} - {y}_{min , k}^{w} ) . \qquad ( Equation 12 )$$

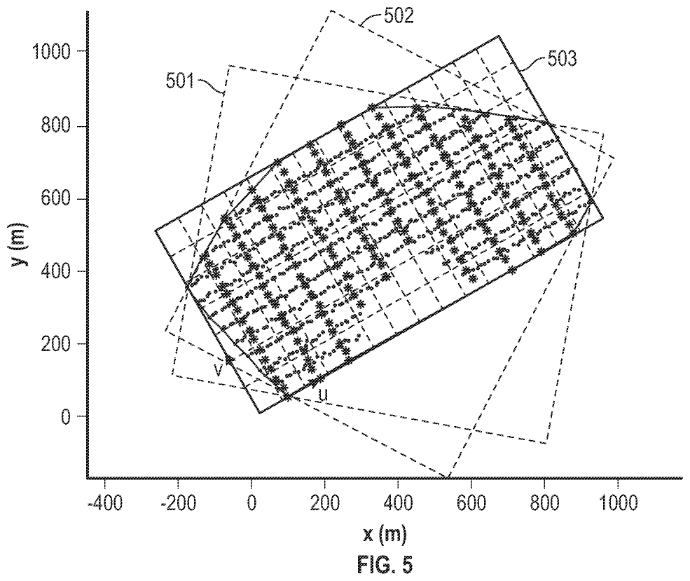

FIG. 5 shows a schematic depiction of three candidate bounding boxes (501)-(503) for the survey. The minimum bounding box is the 503, as it covers the least amount of area. 501 and 502 are suboptimal choices, as they occupy larger area than the 503. As such, 501 and 502 are rejected. The axes of the new (u, v) coordinate system are aligned with the sides of the minimum bounding box.

In Block 304, two linear maps are determined based on the bounding box using a rotation angle and an axis origin. Initially, the minimum bounding box leads to an optimal rotation by θₒₚₜ radians and a new origin (x_{orig}, y_{orig}). The optimal rotation and the new origin are used to construct a linear map from the world coordinate system (x, y) to a grid coordinate system (u, v),

$$[ \begin{matrix}u \\ v \\ 1\end{matrix} ] = [ \begin{matrix}1 / δ u & 0 & 0 \\ 0 & 1 / δ v & 0 \\ 0 & 0 & 1\end{matrix} ] [ \begin{matrix}1 & 0 & - {x}_{orig} \\ 0 & 1 & - {y}_{orig} \\ 0 & 0 & 1\end{matrix} ] [ \begin{matrix}cos ( {θ}_{opt} ) & sin ( {θ}_{opt} ) & 0 \\ - sin ( {θ}_{opt} ) & cos ( {θ}_{opt} ) & 0 \\ 0 & 0 & 1\end{matrix} ] [ \begin{matrix}x \\ y \\ 1\end{matrix} ] . \qquad ( Equation 12 )$$

The parameters δu and δv are supplied by the user and define the grid spacing along the u and v-axis, respectively. In one or more embodiments, distributing traces to grid cells may be then performed by grouping together traces for which └u┘ is the same and └v┘ is the same, └ ┘ denoting the floor operation. If no distribution of traces is to be performed and no coordinate scaling is needed, the user can set δu←δv←1.

The inverse map, from (u, v) to (x, y), is given by

$$[ \begin{matrix}x \\ y \\ 1\end{matrix} ] = [ \begin{matrix}cos ( {θ}_{opt} ) & - sin ( {θ}_{opt} ) & 0 \\ sin ( {θ}_{opt} ) & cos ( {θ}_{opt} ) & 0 \\ 0 & 0 & 1\end{matrix} ] [ \begin{matrix}1 & 0 & {x}_{orig} \\ 0 & 1 & {y}_{orig} \\ 0 & 0 & 1\end{matrix} ] [ \begin{matrix}δ u & 0 & 0 \\ 0 & δ v & 0 \\ 0 & 0 & 1\end{matrix} ] [ \begin{matrix}u \\ v \\ 1\end{matrix} ] . \qquad ( Equation 13 )$$

This pair of linear maps may be used to seamlessly process a dataset in grid coordinates and return the result in world coordinates for further processing and interpretation.

In Block 305, a geological model of the subsurface, including reservoir models of hydrocarbon reservoirs within the subterranean region of interest, is generated using the grid constructed using the two linear maps. In other words, the linear maps are not used directly to obtain geological models of the subsurface, but are rather used to define a grid, which later can be populated by geological models. Geological models may include the locations of geological interfaces, such as the boundary between volumes (“formations”) containing different rock types (“facies”), and faults and fractures. Geological models may also include descriptions of the characteristics of the different facies including characteristics such as porosity and permeability, and the relative amounts of different fluids, such as gas, oil and brine, within the pores in each facies.

In some embodiments, the geological models may be used directly to create a wellbore drilling plan using a wellbore planning system. Such a wellbore drilling plan may contain drilling targets: geological regions expected to contain hydrocarbons. The wellbore planning system may plan wellbore trajectories to reach the drilling targets while simultaneously avoiding drilling hazard, such as preexisting wellbores, shallow gas pockets, and fault zones, and not exceeding the constraints, such as torque, drag and wellbore curvature, of the drilling system. Similarly, the wellbore drilling plan may include a determination of wellbore caliper, and casing points.

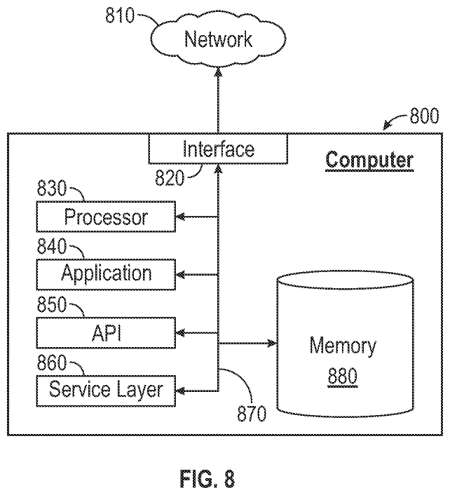

The wellbore planning system may include dedicated software stored on a memory of a computer system, such as the computer system shown in FIG. 8. The wellbore plan may be informed by the best available information at the time of planning. This may include models encapsulating subterranean stress conditions, the trajectory of any existing wellbores (which may be desirable to avoid), and the existence of other drilling hazards, such as shallow gas pockets, over-pressure zones, and active fault planes.

The wellbore plan may further define associated drilling parameters, such as the planned depths at which casing will be inserted to support the wellbore to prevent formation fluids entering the wellbore and the drilling mud weights (densities) and types that may be used during drilling of the wellbore.

In other embodiments, the geological model may be input to a reservoir simulator. A reservoir simulator comprises functionality for simulating the flow of fluids, including hydrocarbon fluids such as oil and gas, through a hydrocarbon reservoir composed of porous, permeable reservoir rocks in response to natural and anthropogenic pressure gradients. The reservoir simulator may be used to predict changes in fluid flow, including fluid flow into well penetrating the reservoir as a result of planned well drilling, and fluid injection and extraction. For example, the reservoir simulator may be used to predict fluid-flow and production scenarios including changes in hydrocarbon production rate that would result from the injection of water into the reservoir from wells around the reservoirs periphery.

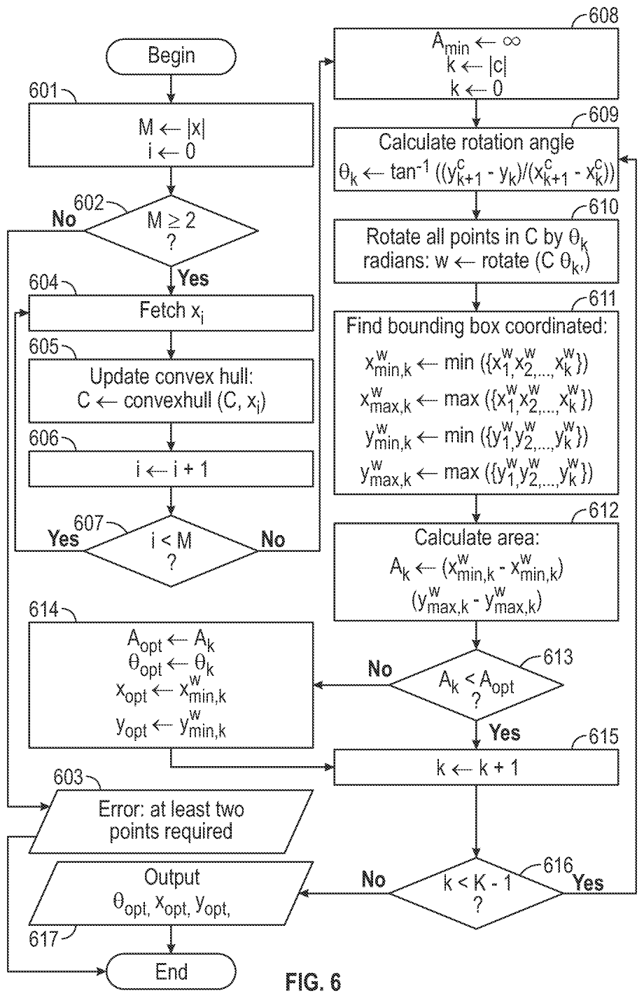

FIG. 6 shows a flowchart in accordance with one or more embodiments. Further, to the general description provided in FIG. 3, FIG. 6 shows an exemplary flowchart, which illustrates a method for minimum bounding box-based grid determination described in Steps 302-304. Further, one or more blocks in FIG. 6 may be performed by one or more components as described in FIG. 2. While the various blocks in FIG. 6 are presented and described sequentially, one of ordinary skill in the art will appreciate that some or all of the blocks may be executed in a different order, may be combined or omitted, and some or all of the blocks may be executed in parallel. Furthermore, the blocks may be performed actively or passively.

Initially, in Step 601, the grid determination simulator (112) obtains the number of all recorded traces [symbol] and stores it as variable M. Additionally, an iterator i is assigned value 0. In Step 602, the value M, representing the number of traces, is required to be larger than 2. If the set contains less than two values, in Step 603, it is not necessary to construct the minimum bounding box. Alternatively, iterative process is occurring in Steps 604-607.

Initially, a new point xᵢ is fetched in Step 604. The convex hull function is updated with xᵢ in Step 605 and iterator i is increased by 1 in Step 606. This process runs iteratively until every trace is added to the convex hull, as required by Step 607.

Further, in Step 608, minimum area of the bounding box is assigned value of infinity to start with a maximum value. Variable K and iterator k are assigned the number of points defining the convex hull and 0, respectively. An iterative process is occurring in Steps 609-616.

Specifically, in Step 609 the rotation angle is calculated based on Equation 5. Further, in Step 610, all points in C are rotated by the rotation angle values. After rotating the points by the determined rotation angle, in Step 611, the bounding box coordinates are determined using Equations 8-11. Specifically, minimum and maximum coordinates are determined for each selected starting point. Based on the determined coordinates, in Step 612, the area is calculated based on Equation 12. In Step 613, a comparison is made between the calculated area and minimum area obtained in previous iterations. If the calculated area is smaller than the minimum area obtained in the previous iterations, then in Step 614, the area value, rotation angle value, and origin values are updated with the values of the current iteration. Regardless of the comparison, the iterator is increased by 1, in Step 615. The process is repeated until all points in C are considered in Step 616. Values of the minimum bounding box are outputted to the user in Step 617.

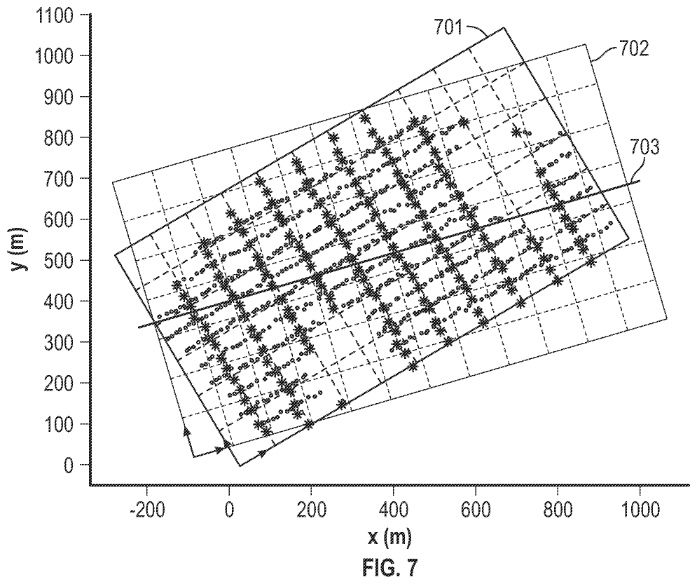

FIG. 7 shows an example of method for minimum bounding box-based grid determination in accordance with one or more embodiments. For exemplary purposes, acquisition layout that contains gaps (e.g., areas where sources and/or receivers could not be placed) is examined. Specifically, in marine acquisitions the acquisition layout that contains gaps may occur if islands are present within the survey area. Further, in land acquisitions, difficult terrain and other obstructions such as presence of infrastructure may create gaps in the acquisition geometry. The existence of gaps may influence the automatic grid determination process, depending on the method used.

The method that will be used as a reference for comparison purposes is least-squares linear regression, which also may be used to extract a rotation angle to be used for producing a survey grid. The method works by solving the optimization problem

$${min}_{a} \{ {‖ y - Xa ‖}_{2}^{2} \} , \qquad ( Equation 14 )$$

$$where$$

$$y := [ \begin{matrix}{y}_{1}^{s} \\ {y}_{2}^{s} \\ ⋮ \\ {y}_{N}^{s} \\ {y}_{1}^{r} \\ {y}_{2}^{r} \\ ⋮ \\ {y}_{N}^{r}\end{matrix} ] , X := [ \begin{matrix}{x}_{1}^{s} & 1 \\ {x}_{2}^{s} & 1 \\ ⋮ & \\ {x}_{N}^{s} & 1 \\ {x}_{1}^{r} & 1 \\ {x}_{2}^{r} & 1 \\ ⋮ & \\ {x}_{N}^{r} & 1\end{matrix} ] and a := [ \begin{matrix}α \\ β\end{matrix} ] . \qquad ( Equation 15 )$$

The vector y and matrix X are constructed using both the source and receiver coordinates, but it may be possible to use any desired subset of [symbol] , as long as the desired subset of [symbol] contains at least two non-coinciding points. The elements α and β of the parameter vector a represent the slope and y-intercept of the fitted line. The solution has the closed form

$$a = {( {X}^{T} X )}^{- 1} {X}^{T} y . \qquad ( Equation 15 )$$

The rotation being sought is then given by the arctangent of the slope, extracted from a,

$${θ}_{lin} = {tan}^{- 1} ( α ) . \qquad ( Equation 15 )$$

The rotation θₗᵢₙ is then used to construct the new coordinate system, as described in FIGS. 3 and 6.

FIG. 7 shows two survey grids, one designed by the minimum bounding box method (701) and one using the linear regression method (702). The survey contains two gaps, where sources and receivers are absent. Both source and receiver locations were used in both methods to construct the respective grids.

Line (703) plotted throughout the survey is the line fitted by the linear regression. This line (703) is influenced by the presence of the acquisition gaps, as the optimization problem minimizes the sum of the Euclidian distance of each source/receiver location from the point on the line sharing the same abscissa. This, in turn, will influence the slope estimation and therefore the grid definition and may lead to a grid that has an increased number of unoccupied grid cells, as is the case in FIG. 7. The minimum bounding box method is not influenced in the same way, as it is sensitive only to changes along the boundary of the survey rather than its interior.

Embodiments may be implemented on any suitable computing device, such as the computer system shown in FIG. 8. FIG. 8 is a block diagram of a computer system (800) used to provide computational functionalities associated with described algorithms, methods, functions, processes, flows, and procedures as described in the instant disclosure, according to an implementation. Additionally, the embodiments may be implemented as a standalone software or a plug-in using another software to operate. The illustrated computer (800) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (800) may include a computer that includes an input device, such as a keypad, keyboard, touch screen, or other device that can accept user information, and an output device that conveys information associated with the operation of the computer (800), including digital data, visual, or audio information (or a combination of information), or a GUI.

The computer (800) can serve in a role as a client, network component, a server, a database or other persistency, or any other component (or a combination of roles) of a computer system for performing the subject matter described in the instant disclosure. The illustrated computer (800) is communicably coupled with a network (810). In some implementations, one or more components of the computer (800) may be configured to operate within environments, including cloud-computing-based, local, global, or other environment (or a combination of environments).

At a high level, the computer (800) is an electronic computing device operable to receive, transmit, process, store, or manage data and information associated with the described subject matter. According to some implementations, the computer (800) may also include or be communicably coupled with an application server, e-mail server, web server, caching server, streaming data server, business intelligence (BI) server, or other server (or a combination of servers).

The computer (800) can receive requests over network (810) from a client application (for example, executing on another computer (800) and responding to the received requests by processing the said requests in an appropriate software application. In addition, requests may also be sent to the computer (800) from internal users (for example, from a command console or by other appropriate access method), external or third-parties, other automated applications, as well as any other appropriate entities, individuals, systems, or computers.

Each of the components of the computer (800) can communicate using a system bus (870). In some implementations, any or all of the components of the computer (800), both hardware or software (or a combination of hardware and software), may interface with each other or the interface (820) (or a combination of both) over the system bus (870) using an application programming interface (API) (850) or a service layer (860) (or a combination of the API (850) and service layer (860). The API (850) may include specifications for routines, data structures, and object classes. The API (850) may be either computer-language independent or dependent and refer to a complete interface, a single function, or even a set of APIs. The service layer (860) provides software services to the computer (800) or other components (whether or not illustrated) that are communicably coupled to the computer (800). The functionality of the computer (800) may be accessible for all service consumers using this service layer. Software services, such as those provided by the service layer (860), provide reusable, defined business functionalities through a defined interface. For example, the interface may be software written in JAVA, C++, or other suitable language providing data in extensible markup language (XML) format or other suitable format. While illustrated as an integrated component of the computer (800), alternative implementations may illustrate the API (850) or the service layer (860) as stand-alone components in relation to other components of the computer (800) or other components (whether or not illustrated) that are communicably coupled to the computer (800). Moreover, any or all parts of the API (850) or the service layer (860) may be implemented as child or sub-modules of another software module, enterprise application, or hardware module without departing from the scope of this disclosure.

The computer (800) includes an interface (820). Although illustrated as a single interface (820) in FIG. 8, two or more interfaces (820) may be used according to particular needs, desires, or particular implementations of the computer (800). The interface (820) is used by the computer (800) for communicating with other systems in a distributed environment that are connected to the network (810). Generally, the interface (820 includes logic encoded in software or hardware (or a combination of software and hardware) and operable to communicate with the network (810). More specifically, the interface (820) may include software supporting one or more communication protocols associated with communications such that the network (810) or interface's hardware is operable to communicate physical signals within and outside of the illustrated computer (800).

The computer (800) includes at least one computer processor (830). Although illustrated as a single computer processor (830) in FIG. 8, two or more processors may be used according to particular needs, desires, or particular implementations of the computer (800). Generally, the computer processor (830) executes instructions and manipulates data to perform the operations of the computer (800) and any algorithms, methods, functions, processes, flows, and procedures as described in the instant disclosure.

The computer (800) also includes a memory (880) that holds data for the computer (800) or other components (or a combination of both) that can be connected to the network (810). For example, memory (880) can be a database storing data consistent with this disclosure. Although illustrated as a single memory (880) in FIG. 8, two or more memories may be used according to particular needs, desires, or particular implementations of the computer (800) and the described functionality. While memory (880) is illustrated as an integral component of the computer (800), in alternative implementations, memory (880) can be external to the computer (800).

The application (840) is an algorithmic software engine providing functionality according to particular needs, desires, or particular implementations of the computer (800), particularly with respect to functionality described in this disclosure. For example, application (840) can serve as one or more components, modules, applications, etc. Further, although illustrated as a single application (840), the application (840) may be implemented as multiple applications (840) on the computer (800). In addition, although illustrated as integral to the computer (800), in alternative implementations, the application (840) can be external to the computer (800).

There may be any number of computers (800) associated with, or external to, a computer system containing computer (800), each computer (800) communicating over network (810). Further, the term “client,” “user,” and other appropriate terminology may be used interchangeably as appropriate without departing from the scope of this disclosure. Moreover, this disclosure contemplates that many users may use one computer (800), or that one user may use multiple computers (800).

In some embodiments, the computer (800) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (Saas), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method comprising:
obtaining a seismic survey of an area;
constructing, using a computer processor, a convex hull of the seismic survey area;
determining, using the computer processor, a minimum bounding box containing a minimum convex hull area;
generating, using the computer processor, two linear maps based on the minimum bounding box using a rotation angle and an axis origin; and
generating, using the computer processor and two linear maps, a grid populated by geological models of a subsurface.

2. The method of claim 1, wherein the seismic survey of the area is obtained using a predetermined acquisition geometry, the predetermined acquisition geometry being defined by a plurality of spatial locations where a source is activated and a set of spatial coordinates where receivers are placed.

3. The method of claim 1, wherein constructing the convex hull of the seismic survey area comprises:
determining, using the computer processor, a plurality of spatial locations including a plurality of sources and a plurality of receivers; and
constructing, using the computer processor, the convex hull by iteratively processing the plurality of spatial locations.

4. The method of claim 1, wherein a translation between world and grid coordinates is based on the two linear maps.

5. The method of claim 4, wherein the world coordinates are processed sequentially, one by one.

6. The method of claim 1, wherein determining a bounding box containing the minimum convex hull area comprises:
determining, using the computer processor, the rotation angle and the axis origin;
determining, using the computer processor, a plurality of rotated coordinates based on the rotation angle and the axis origin; and
calculating, using the computer processor, the area of the bounding box based on the plurality of the rotated coordinates.

7. The method of claim 6, wherein the minimum bounding box is the bounding box with a smallest area.

8. A non-transitory computer readable medium storing instructions executable by a computer processor, the instructions comprising functionality for:
obtaining a seismic survey of an area;
constructing a convex hull of the seismic survey area;
determining a minimum bounding box containing a minimum convex hull area;
generating two linear maps based on the bounding box using a rotation angle and an axis origin; and
generating, using the two linear maps, a grid populated by geological models of a subsurface.

9. The non-transitory computer readable medium of claim 8, wherein the seismic survey of the area is obtained using a predetermined acquisition geometry, the predetermined acquisition geometry being defined by a set of spatial locations where a source is activated and a set of spatial coordinates where receivers are placed.

10. The non-transitory computer readable medium of claim 8, wherein constructing the convex hull of the seismic survey area comprises:
determining a plurality of spatial locations including a plurality of sources and a plurality of receivers; and
constructing the convex hull by iteratively processing the plurality of spatial locations.

11. The non-transitory computer readable medium of claim 8, wherein a translation between world and grid coordinates is based on the two linear maps.

12. The non-transitory computer readable medium of claim 11, wherein the world coordinates are processed sequentially, one by one.

13. The non-transitory computer readable medium of claim 8, wherein determining a bounding box containing the minimum convex hull area comprises:
determining the rotation angle and the axis origin;
determining a plurality of rotated coordinates based on the rotation angle and the axis origin; and
calculating the area of the bounding box based on the plurality of the rotated coordinates.

14. The non-transitory computer readable medium of claim 13, wherein the minimum bounding box is the bounding box with a smallest area.

15. A system comprising:
a processor configured to:
obtain a seismic survey of an area;
construct a convex hull of the seismic survey area;
determine a minimum bounding box containing a minimum convex hull area;
generate two linear maps based on the bounding box using a rotation angle and an axis origin; and
generating, using the two linear maps, a grid populated by geological models of a subsurface.

16. The system of claim 15, wherein the seismic survey of the area is obtained using a predetermined acquisition geometry, the predetermined acquisition geometry being defined by a plurality of spatial locations where a source is activated and a set of spatial coordinates where receivers are placed.

17. The system of claim 15, wherein constructing the convex hull of the seismic survey area comprises:
determining a plurality of spatial locations including a plurality of sources and a plurality of receivers; and
constructing the convex hull by iteratively processing the plurality of spatial locations.

18. The system of claim 15, wherein a translation between world and grid coordinates is based on the two linear maps.

19. The system of claim 18, wherein the world coordinates are processed sequentially, one by one.

20. The system of claim 15, wherein determining a bounding box containing the minimum convex hull area comprises:
determining the rotation angle and the axis origin;
determining a plurality of rotated coordinates based on the rotation angle and the axis origin; and
calculating the area of the bounding box based on the plurality of the rotated coordinates.
